(19) United States
(12) Patent Application Publication
(10) Pub. No.: US 2010/0123375 A1
(43) Pub. Date: May 20, 2010

(54) Locking System for Filing Cabinets to Prevent More than One Drawer being Open at One Time

(75) Inventors: Andrew Romaen, Chicago, IL (US); Edward Karl Freimuth, Palos Heights, IL (US)

Correspondence Address: EDELSON IP LAW GROUP, LTD., PO BOX 230, DEERFIELD, IL, 60015, US

(73) Assignee: Versatility Tool Works & Manufacturing Company, Inc., Alsip, IL (US)

(21) Appl. No.: 12/272,491

(22) Filed: Nov. 17, 2008

(51) Int. Cl. E05B 65/46

(52) U.S. Cl. 312/215

(57) ABSTRACT

A cabinet interlocking system is disclosed for a cabinet comprising a plurality of drawers wherein the interlocking system acts to prevent more than one drawer being opened at one time. The interlocking system comprises: a) an application of wedge-shaped support members for each movable side, or on at least one side, (could also be mounted on just one side), of each drawer to support each drawer in an open and closed position, b) a set of movable interlocking spring-loaded interlocking pieces mounted on adjoining support walls of the cabinet upon which the wedge-shaped drawer slides support members applied to the sides of the cabinet drawers of the cabinet drawers remain when the drawers are in the open position, c) a locking mechanism comprising a key-operated locking bracket and a key operated locking bar, which operate to lock and unlock the set of movable interlocking spring-loaded interlocking piece to permit the movable interlocking pieces to move upon entrance of the wedge-shaped members to penetrate between the interlocking members upon opening of one cabinet drawer, to raise the interlocking support members of the other interlocking pieces of other cabinet drawers above the open drawer to prevent opening the other cabinet drawers, above the open drawer. Also, cabinet drawers are blocked from opening by a spatial constraint there being only enough space between the several spring loaded interlocking pieces to allow one and only one wedge shaped member to pass between members of one interlocking piece.

### BACKGROUND OF THE INVENTION

The present invention relates to filing cabinets, and more particularly to mechanisms designed to prevent more than one drawer in a filing cabinet from being opened.

Filing cabinets and containers containing two or more drawers are used to store items, documents, heavy files, tools, supplies, and other materials. In some instances, the opening of two drawers or more in such a cabinet at the same time can cause the cabinet to tip over and possibly cause serious injury to someone or damage to the items stored in the cabinet. In order to prevent the simultaneous opening of two drawers of such a cabinet and prevent the tipping over of the cabinet, the present invention provides a systemized mechanism where space limitations are a vital concern. The present invention, cabinets, is provided with an interlocking mechanism preventing a second drawer of the cabinet from being opened after a first drawer has been opened.

The present invention is also unique in that the cabinet can be designed with different sections, such as a top section with drawers and a bottom section with drawers, or left-hand side with drawers and right-hand side with drawers. The present invention then provides for the ability that each section could have a single drawer opened, while the other remaining drawers stay locked.

Filing cabinets are most often equipped with locks preventing any drawers from being opened. The lock is moved to a locking or closed position. The lock overrides any system designed to allow movement in a cabinet. In the prior art interlocking systems when the lock is activated no drawers can be opened at all. In the prior art cabinets, the lock must be activated or moved to a certain position to allow a drawer to open. The prior art interlock system functions to prevent the drawers from opening or only allowing one drawer to be opened where the lock is set to a certain position.

A system of locking all of the drawers and having an interlocking system that locks all but one of the drawers where space is a vital concern has not been developed until the present invention. The present invention provides for a significant number of components to be integrated and functionally combined to significantly reduce the space requirements and thereby reduce the weight of the cabinet. The present inventive cabinet combines an interlocking system with a locking mechanism so spatial constraints in the cabinet are not an impediment, and the present invention allows for the opening of a single drawer, if desired, in the cabinet without having to adjust the locking mechanism.

As noted, the current methods employed in cabinets or containers utilized today do not solve the issue of space limitations. Further, the reduction in parts, and therefore the reduced cost in production, in conjunction with the integration of common elements utilized in the locking system and the interlocking system of the cabinet or container provide significant cost reductions. By utilizing common parts, the reduction in breakage in the number of components is reduced, and a reduction in the weight of the cabinet is a result. Therefore, the reduction in components provides for easier and better mobilization of the cabinet, and a greater use of the storage space in a cabinet or container than was previously available.

Additionally, one of the other advantages of the present invention is a set of top drawers can be isolated or controlled from a bottom set of drawers allowing a single drawer to open from the different sections of the cabinet whether an upper or lower section of the cabinet. It should also be apparent that the present invention could be manufactured to allow for control of opening of a single drawer from a right-hand section of the cabinet or container and the opening of a single drawer from a left hand section of the cabinet or container.

As noted above, the locking and interlocking mechanisms known in the prior art have suffered from a number of disadvantages. A particular disadvantage is that many of these systems are complicated, and require complicated assembly and parts, with significant space requirements. For example, U.S. Pat. No. 4,355,851 is directed to a file cabinet including slidably mounted drawers, provided with an interlock mechanism preventing the simultaneous opening of two drawers. The interlock mechanism includes an elongated channel having a fixed length and depth. Blocks and wedges are slidable within the channel along the length thereof. This system further includes and requires a cam means and an actuator for forcing wedges into the channel.

Many systems are designed to prevent a second drawer from opening when a first drawer is already open, however, none has the added flexibility noted above of controlling sections of the drawers and allowing if desired, only a single drawer to open for that particular section.

In light of the foregoing, the desirability of combining an interlocking and locking system to overcome the prior art disadvantages and space limitation can be seen in the present invention.

### SUMMARY OF THE INVENTION

The present invention provides a multi-drawer cabinet having an interlock mechanism preventing two or more drawers from being simultaneously opened. The present invention provides or allows if desired the opening of only one drawer, or if the cabinet or container is sectioned, the allowance of only a single drawer to be opened in that particular section. In addition, the following system is based on a minimal number of components of relatively easy design and assembly and employed where space is a major limitation in the cabinet housing.

The cabinet interlocking system is designed for multi-drawer cabinets. The cabinet or container interlock system includes a cabinet frame, with the usual drawer housing, and a vertical support member on an inner side panel of the cabinet. The vertical support member has slots for supporting interlock pieces. The interlock pieces are vertically stacked and member portions of the piece protrude through the slots, while the remaining portion of the interlock piece serves to space the protruding member portions of other interlocking pieces.

Two protruding members, attached to different spacers of different interlocking pieces are arranged in two slots, as a ‘protrusion pair’, with one protrusion of the pair resting upon the other. Each drawer has a wedge-ended member attached horizontally to a side of the drawer. The wedge-ended members are positioned to penetrate between a set of protrusions pair of interlock pieces when the drawer is opened. Only the locking interlocking members located above the opened drawer are displaced. The bottom interlocking members are not displaced on the drawers that remain closed below the opened drawer. The wedge-ended members exit from between the interlock pieces when the drawer is closed. As the wedge-ended member penetrates the vertically stacked interlock pieces, it causes only the locking members of the interlocking pieces located above the opened drawer to be displaced vertically by the width of the wedge-ended member. Thus, this system provides a spring load to cause the displaced interlocking pieces to return to a neutral position.

The system load includes a spring; the spring helps in returning the interlocking piece members to the correct position. The spring constantly pushes down. Therefore the interlocking pieces are in vertical alignment, and the spatial constraints prevent them from being vertically displaced by more than by one drawer. Again, as noted above it is only the interlocking pieces located above the open drawer are displaced and keep the drawer from locking. In this way, two drawers can never be opened at the same time. As noted in a cabinet or container manufactured with specific sections the present invention allows a drawer from a designated top bank of drawers to be in the open position, while allowing a second opened drawer in a separate section of drawers from a bottom bank of drawers to be opened at the same time if desired. Any additional drawers would not be able to open. The cabinet interlock system of the present invention includes an interlocking bar in an alternative embodiment. The spring at the top of the vertical stack of interlock pieces constantly pushes down to hold the pieces in alignment and the spatial constraint of the cabinet prevents displacement of the interlock pieces by locking the interlock piece closest to the spring in a non-displaced position. A locking bar passes through the vertical support member and into a hollow in the interlock piece closest to the spring. This prevents any drawers from being opened. These and other advantages of the invention will be further understood and appreciated by those skilled in the art by reference to the following written specification, claims, and appended drawings.

### BRIEF DESCRIPTION OF THE DRAWINGS

FIG. 1a: is a perspective view of a cabinet with three drawers in a closed position with wedge-ended members on each movable side,

FIG. 1b: is a perspective view of a drawer with an attached wedge-ended member on one movable side;

FIG. 2a: is a perspective view illustrating operation of the wedge-ended members and interlock pieces according to the present invention;

FIG. 2b: is a perspective view of a wedge-ended member inserted between the interlock pieces, in accordance with the present invention;

FIG. 3a: is a perspective view of the vertical support member 90 for the interlock on inner cabinet wall 21,

FIG. 3b: illustrates T shaped slots 91, which support interlock pieces 30 in vertical position;

FIG. 3c: is a detailed view of an interlock piece positioned mid-support within the vertical support column 90 of FIG. 3a;

FIG. 4: illustrates a detailed view of the spring load and lock of the present invention;

FIG. 4a: illustrates a further detailed view of the support 90 and placement of interlocking pieces 30 in T-shaped slots 91;

FIG. 4b: illustrates the spring load mechanism of spring 61,

FIG. 4c: illustrates the spring upon interlocking pieces 30 load mechanism of FIG. 4b,

FIG. 4d: illustrates the structure of the interlocking pieces 30 as consisting of protrusions 33, 34, and spacer 32; and

FIG. 4e: illustrates the structure of the alternative interlocking piece receiving a locking bar.

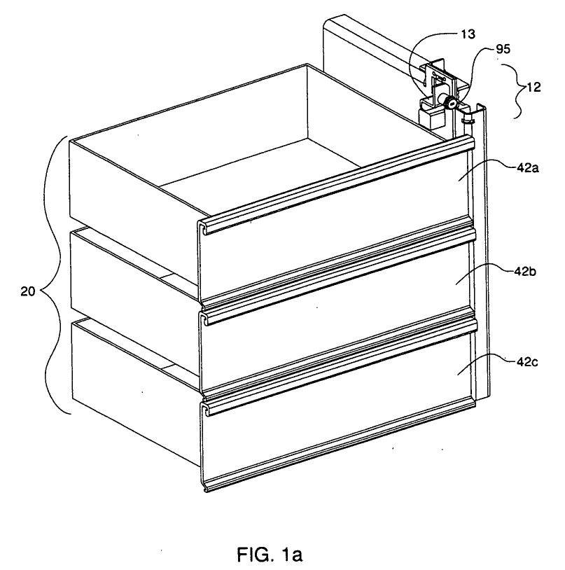

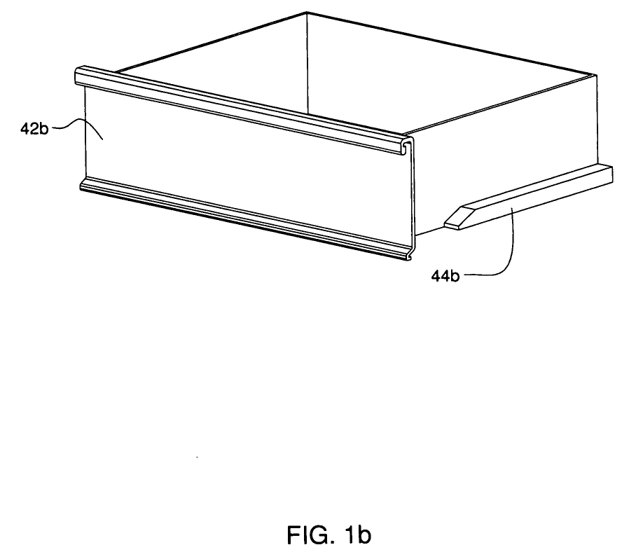

Referring to FIGS. 1a through 4e, the designated parts are numbered consistently throughout the figures and represent the same parts without repeating the specific designation.

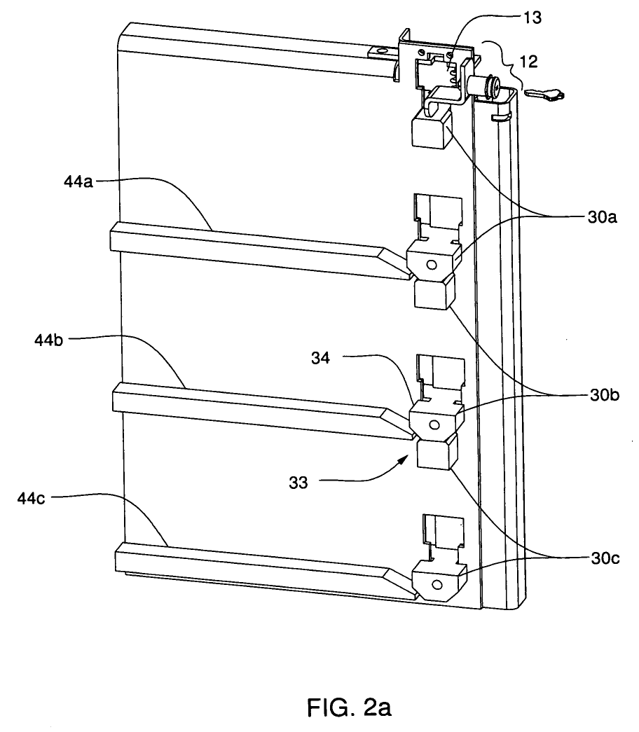

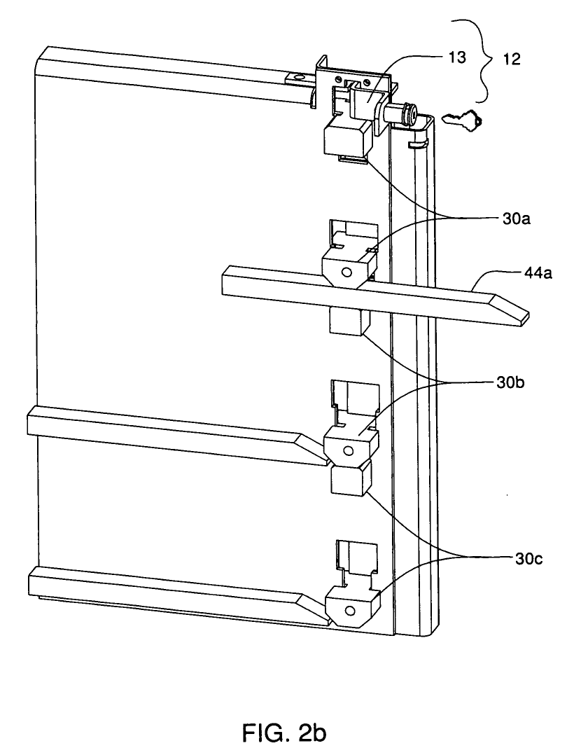

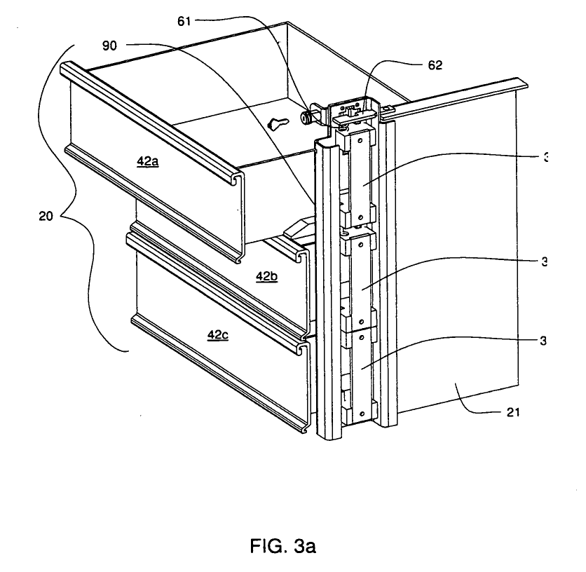

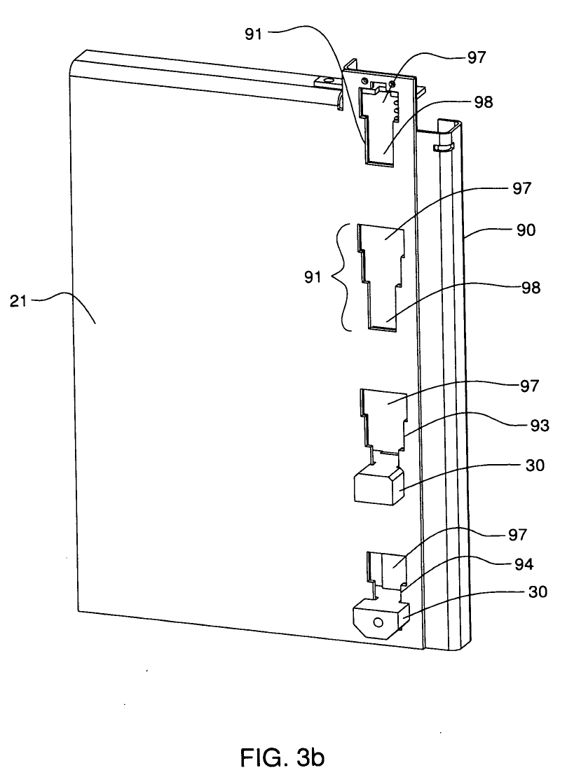

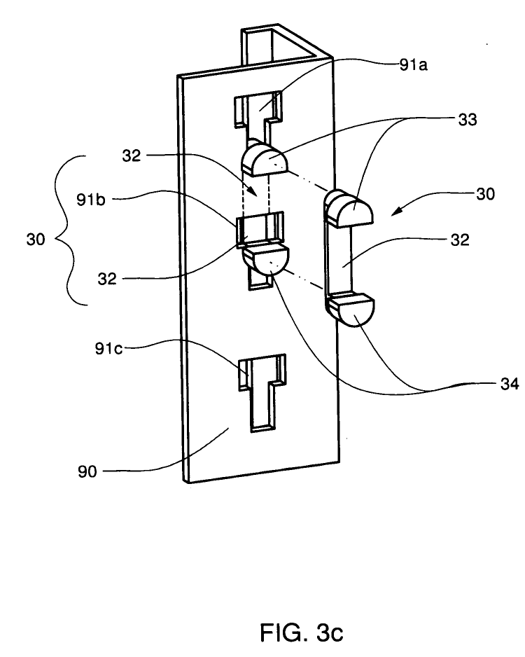

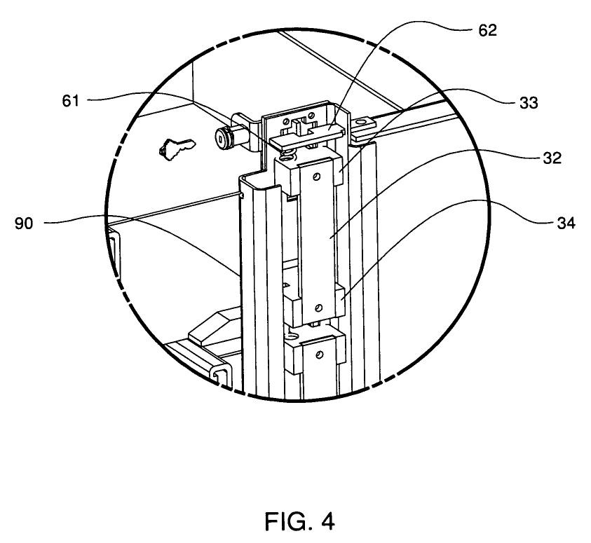

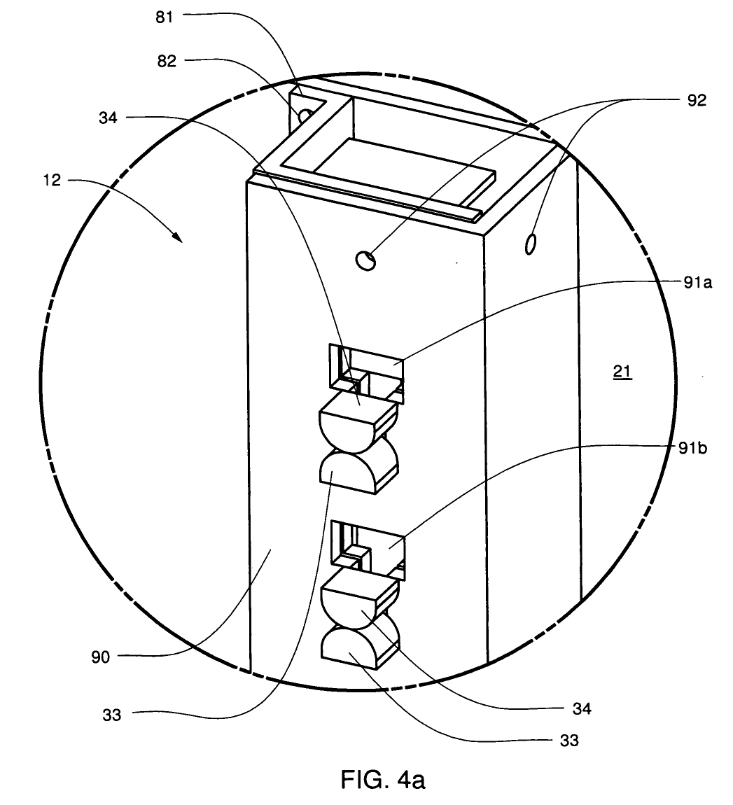

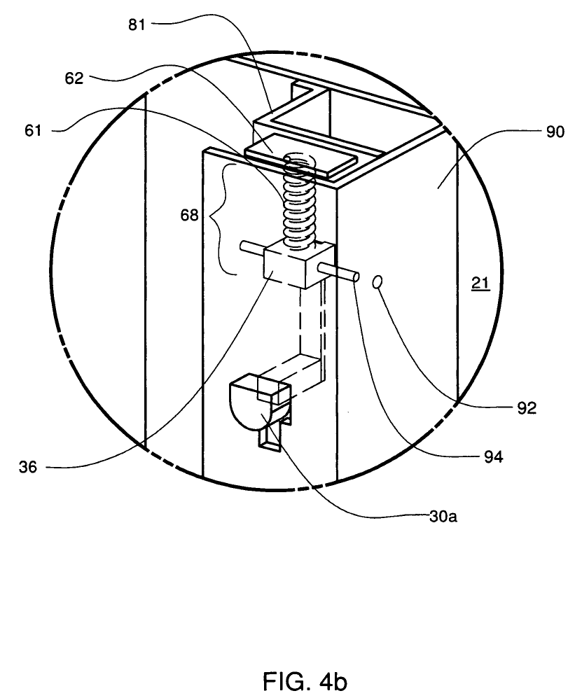

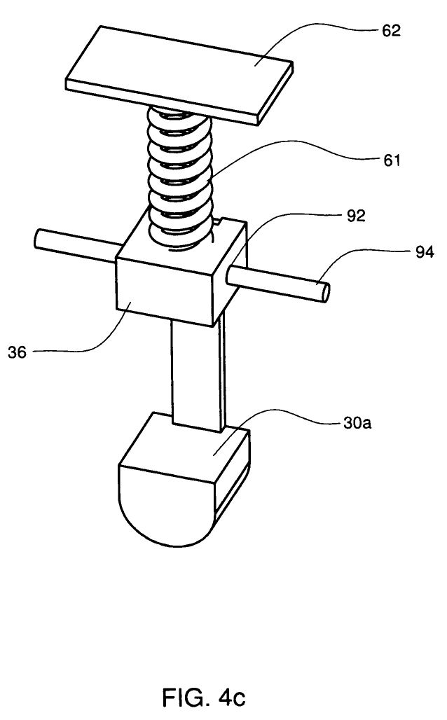

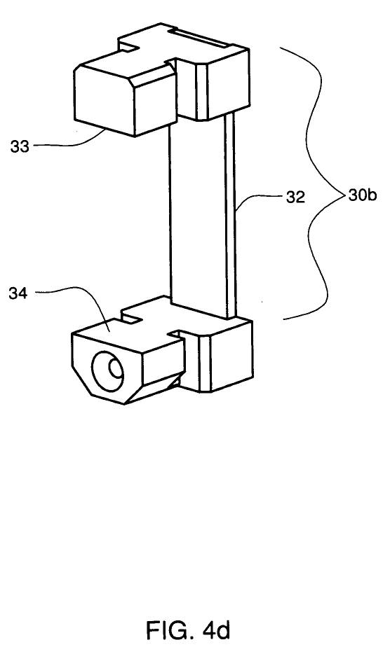

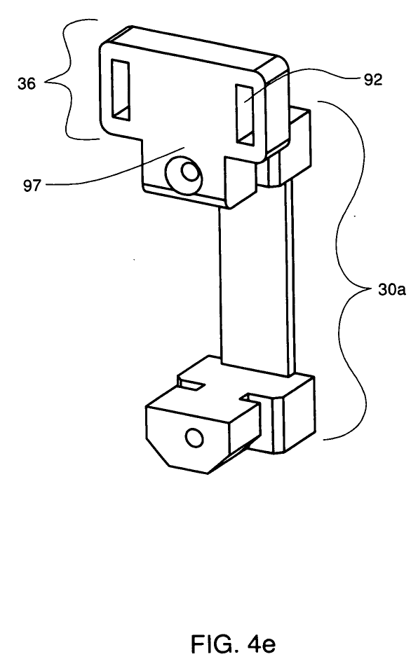

In FIG. 1a, file cabinet assembly 20 comprises 42a, 42b, 42c; lock bracket 13, key hole 95, for lock mechanism 12. FIG. 1b illustrates attachment of draw slide wedge ended member 44b to drawer 42b. FIG. 2a illustrates application of a key to lock mechanism 12 with lock bracket 13 which acts with upper protrusion 30a to lock drawer slide wedge ended member 44a from insertion between lower interlock protrusion 30a and upper protrusion 30b. FIG. 2b illustrates the structure of the invented device wherein interlock protrusion 30a and 30b inserted in wall slots engage drawer slide wedge-ended member 44a and wherein locking mechanism 13 is not operative. FIG. 3a illustrates the construction of the vertical support inner wall 21 of cabinet 20, drawers 42a, 42b, 42c, spring loading 61, spring loading plate 62, interlock spacer 32, vertical support member 90. FIG. 3b illustrates the T-shaped slots 91 consisting of spaces 97, 98; 93 and 94 and interlock protrusions 30. FIG. 3c details the method of inserting interlock piece 30 and interlock protrusions 33, 34 of interlock piece 30 through slots 91a, 91b, and 91c in vertical support member 90 with interlock piece spacer 32. FIG. 4 illustrates the spring loading plate 62, the upper and lower protrusions 33 and 34 of interlock spacer 32, spring 61 and vertical support member 90. FIG. 4a illustrates further details of the interlock piece comprising protrusions 33 and 34 in spaces 91a and 91b in vertical column member 81 wherein inlets 92 are indicated and support screw 82, to cabinet wall 21. FIG. 4b repeats the previous designations of previous FIGS. 1-4a as does FIGS. 4c, and 4d. FIG. 4e illustrates an alternative embodiment of an interlock piece 30a, which engages an inserted lock bar in hollow 92 in the upper protrusion 97 of support element 36.

### DETAILED DESCRIPTION OF THE INVENTION

The present invention will now be described with reference to the accompanying drawings wherein the reference numerals in the following written description correspond to like numbered elements in the several drawings. The present invention relates to locks and interlocks used in file cabinets, tool cabinets, and other containers. A typical file cabinet 20 is depicted in FIG. 1a. A file cabinet assembly 20 has a series of drawers 42a, 42b, and 42c mounted for sliding movement within a cabinet formed of an upper wall 22 (not shown), a lower wall 24 (not shown), and a pair of sidewalls 23, 25 (not shown). Drawer slides 44a, 44b, 44c, (See FIG. 2a) or equivalent mechanisms are interposed between drawers 42a, 42b, 42c and the cabinet walls 23, 25 for providing sliding movement of drawers 42a, 42b, and 42c between an open position and a closed position, locking bracket 13 is shown, FIG. 1a. While only three drawers are illustrated in file cabinet 20, the present invention is applicable to cabinets having any number of drawers, including cabinets designed with sections of drawers.

The present invention includes a locking system with the ability to override the interlocking system. More specifically, when the locking system is activated, no drawers can be opened at any time. When the locking system is deactivated, the interlocking system is activated and the system prevents more than one drawer from being opened at a single time. The locking system may be activated by inserting a key into a keyhole 95 positioned at any suitable location on the file cabinet. The locking and interlocking systems are highly integrated so the components of the interlocking system are used in the locking system.

An interlock mechanism, shown generally at 12, is interposed between the cabinet structure, sidewall 23, and each of drawers 42a, 42b, and 42c. As will be explained, interlock mechanism 12 functions to prevent more than one of drawers 42a, 42b, and 42c from being opened at one time.

FIG. 1b shows drawer 42b and drawer slide wedge-ended member 44b has been attached to its side. Drawer slide wedge-ended member 44 can be of variable thickness for positioning relative to the drawer and is required to be accurately positioned relative to locking mechanism 12. Drawer slide wedge-ended member 44b is attached to drawer 42b.

Referring to FIG. 2a, drawer slide wedge-ended members 44a, 44b, 44c are depicted as they would be situated were they attached to closed drawers. With regard to interlock mechanism 12, interlock mechanism 12 includes a series of interlock pieces collectively, 30, separately 30a, 30b, and 30c, vertically stacked. Interlock pieces are shown, but the invention is not intended to be limited to any particular number of drawers.

In the FIG. 2a, alternative embodiment, it is noted interlock piece 30a comprises an upper protrusion, contact locking bracket 13. Three interlock pieces, see FIG. 4d, collectively 30, designated 30a, 30b, 30c, consist of a spacer 32, and two protrusion blocks, upper protrusion 33, and lower protrusion 34, a protrusion pair, 33, 34 of two interlocking pieces as shown in FIG. 2a. Interlock pieces are preferably formed of Delrin® (polyoxymethylene), or Nylatron® or any other suitably abrasion wear resistant material. The abrasion may be lubricated to reduce the friction caused by the movement of the components. The preferred material noted is one chosen because of ease to machine and reduction of contact friction between wedge-ended members 44a, 44b, 44c, and interlock pieces 30a, 30b, 30c. The present invention is not limited to this material and other materials may be utilized either in combination or separately. Each wedge-ended member 44 intersects two protrusion blocks, 33 and 34, a protrusion pair. As an example, FIG. 2a, drawer slide wedge shaped member 44b is disposed at the point of meeting between lower protrusion block 34 of interlock piece 30b and upper protrusion block 33 of interlock piece 30c. Again, the two meeting protrusions, 33 and 34, may be termed a ‘protrusion pair’, with one protrusion of the pair resting upon the other. The vertical stack of interlock pieces can be said to be composed of a number of protrusion pairs, separated by spacers.

Each drawer has a drawer slide wedge-ended member attached horizontally to a side of the drawer. The wedge-ended members, collectively 44, individually 44a, 44b, and 44c are positioned to penetrate between a protrusion block pair of interlock pieces, collectively 30, individually 30a, 30b, and 30c when the drawer is opened. Drawer slide wedge-ended members exit from between the interlock pieces when the drawer is closed. As the drawer slide wedge-ended member penetrates the vertically stacked interlock block pieces, it causes them to displace vertically by the width of the wedge-ended member. Only the pieces immediately above the drawer to be opened are displaced vertically.

To help wedge-ended members 44 to penetrate between interlock pieces 30, and to reduce friction and wear and tear, it is recommended the sections of interlock pieces 30 adjacent to the wedge-shaped members' entry point be domed, or tapered. Thus, each protrusion pair consists of a higher protrusion 33, and a lower protrusion 34. The higher protrusion 33 of the pair consists of a flat upper profile with a tapered lower profile. The lower protrusion 34 of the pair has a flat upper profile and a tapered lower profile. A ‘tapered profile’ includes a discrete number of straight sides, or a rounded or domed profile, to promote penetration of said wedge-ended member. The protrusion pair consists of lower protrusion 34 of an interlocking piece 30 and the upper protrusion 33 of a separate interlocking piece 30 to form a protrusion pair with a higher and a lower protrusion.

Drawer slide wedge-ended members 44 have a long lower edge versus a shorter upper edge, forming a prolonged triangular presentation. This provides for easier penetration of the stack of interlock pieces 30. Prolonged lower edge of wedge-ended members 44 eases the meeting point of each protrusion pair.

The various interlock pieces, collectively 30, are not joined to one another but are stacked and held in vertical alignment. Spring loading means 61, 62 is attached to the top of the vertical stack. Spring loading means 61, 62 can alternatively be attached to the base of the stack, or to the middle of the vertical stack of interlock pieces 30a, 30b, 30c. Spring loading means 61, 62 helps in returning the stack to the neutral or closed position, and the stack of interlock pieces 30a,30b, and 30c only requires a small displacement accordingly, substantially equal to the width of wedge-ended member 44a, 44b, or 44c, so one wedge-ended member 44a, 44b, or 44c penetrates through the stack. The limited displacement effectively means two different drawers cannot be simultaneously opened, and a second drawer cannot be opened if a different one is already open.

In an alternate embodiment, top interlock piece 36 is unique in FIG. 4b. It is closest to the spring load means 61, 62. It does not include an upper protrusion 33 positioned opposite a wedge-ended member 44, since its lower protrusion 30a is positioned opposite the top most drawer wedge-ended member 44a. However, top interlock piece 36 may include instead a key-locking mechanism bar locking mechanism. In an alternate embodiment, the locking mechanism is in the form of a hollow 92 in interlock 36 allowing the insertion of a locking bar from the side or front wall of the cabinet. Bottom interlock piece 30 may also be manufactured slightly differently from the other interlock pieces 30 depending on design considerations; for example, it may not require its lower protrusion 34, other than to wedge into position. Therefore, in a further embodiment, bottom interlock piece 34 may be fixedly attached into position.

In a preferred embodiment, FIG. 2b shows locking system 12 with wedge-ended member 44a inserted amidst the stack of interlock pieces 30a, 30b, 30c, indicating the first drawer has been opened. As may be seen, interlock piece 30a above wedge-ended member 44a has been displaced upwards against the spring loading mechanism 61, 62, which is fully compressed. Interlock pieces below member 44a have not moved at all.

With reference now to FIG. 3a, a vertical support member 90 for the interlock system 12 is depicted. A vertical support member is part of or attached to inner wall 21 of cabinet 20, the same wall as outer wall 23. The vertical support member provides guiding support for the vertical stack of interlock pieces, and in a preferred embodiment incorporates T shaped slots 91 to support the interlock pieces. The invention is not limited to T shaped slots 91 slots of different shapes and sizes may be utilized. T shaped slot 91 shown in FIG. 3b is depicted as divided into two distinct and mutually exclusive sections, horizontal sections 97 and 93, and vertical sections 98, and 94. In reality, T shaped slot 91 is not divided at all, but for clarity they are described as if they contain several sections. The benefit of the T shaped slot(s) 91 is the interlock pieces may be inserted into the horizontal section 97 of the T shaped slot(s) 91, and then dropped down to a narrow vertical lower section 98. In vertical section 98, the interlock piece cannot move from side to side. In addition, vertical section 98 is high enough that even at maximum displacement of operational usage, the interlock pieces will not rise high enough to reach horizontal section 97, thus they remain properly confined. Hence, the spatial restraint of the interior of the cabinet frame helps in channeling the displacement of the interlocking mechanism, and provides for allowing only one drawer to be opened in a cabinet or section of a cabinet if so desired. Although the slots are referred to as T shaped, this description is intended to include the possibility that the horizontal section of the T shaped slots may be rounded. Again, the T configuration is not the only available configuration to provide the necessary support and configuration for locking the appropriate component.

FIG. 3c depicts an inserted sample interlock piece 30 as it would appear once inserted into T shaped slots 91a and 91b. To insert sample interlock piece 30 into the T shaped slots, sample interlock piece 30 is held from behind vertical support member 90. Upper protrusion 33 is inserted towards the viewer into the horizontal section of the T shaped slot 91a whilst lower protrusion 34 is inserted into the horizontal section of T shaped slot 91b. Sample interlock piece 30 is then allowed to drop down, so that upper protrusion 33 hangs from the base of the vertical section of T shaped slot 91a, while lower protrusion 34 does not reach the base of the horizontal section of T shaped slot 91b. It would instead rest on a lower interlock piece. To set up interlock device 12 it is recommended to start with the lowest interlock piece 30, and then insert all of them, finishing with the spring load at the top. Spacer 32 is shown indistinctly because much of it is behind vertical support member 90, although part of it is visible behind T shaped slot 91b.

FIG. 4 shows locking spring 61 and interlock spaces 32. FIG. 4a shows a locking bar interlock, system 12 attached to cabinet wall 21. Interlock pieces 33 and 34, 30c are visible through T shaped slots 91a and 91b. FIG. 4a shows an additional vertical column member 81 removably attached, by screws 82 or other equivalent mechanisms onto cabinet wall 21. Vertical column member 81 serves to protect interlock pieces 30 from being thrust towards cabinet wall 21. The vertical column member prevents internal slippage of interlock pieces 30 if the filing cabinet is improperly handled. A further alternate embodiment of the present invention is provided in FIG. 4e, a locking bar is inserted into hollow 92.

FIG. 4b shows further details of FIG. 4a with regard to spring loading 61, 62 and interlock piece 30a. Spring 61 is compressed against plate 62 as interlock piece 30a is raised. The interlock system 12 could equally well work upside down, if spring loading 61, 62 were to be alternatively placed under the lowest interlock piece 30. For clarity, the present disclosure was limited to descriptions utilizing upward displacement. Downward displacement is equally anticipated.

FIG. 4c depicts further details of the alternate locking bar system, which could use any locking mechanism known in the art. In an alternative embodiment, FIG. 4e, the top section 36 of topmost interlock piece 30a is formed as a block containing a hollow 92, into which locking bar 94 (not shown) is inserted when it is desired to deactivate the spring and prevent any displacement of the interlock pieces 30. This effectively stops all the drawers from opening. This locking procedure can only be effective if done when all the drawers are initially closed. The locking bar 94 prevents the spring 61 from being compressed and therefore wedge-ended members are prevented from penetrating the series of interlock pieces 30. Since they cannot penetrate, the drawers are unable to open.

FIG. 4e depicts the locking bar. FIG. 4e further depicts an alternative locking bar top section 36 of topmost interlock piece 30a containing a rectangular receptacle for a rectangular shaped locking bar.

The locking system alternatively includes a keyhole and a key, in which the key is operationally connected to the locking device, such as locking bracket 13. The turning of the key in the keyhole causes the locking mechanism to be activated, such as inserting locking bracket 13 over protrusion block 33 of interlock 33a. The present invention further provides a method for building the cabinet of the present invention, in which no more than one drawer can be opened at any given time.

A number of stages are involved:

Providing a filing cabinet frame with a vertical member on an inner side surface of the filing cabinet;

i) attaching a wedge-ended horizontal bar to each of the drawers;
ii) producing T shaped slots on a face of the vertical member facing the drawers;
iii) inserting the top end of a first interlock piece and the bottom end of a second interlock piece into each T shaped slot from behind the slot so protrusions of the interlock pieces protrude towards the drawer spacers of the interlock pieces remain behind the vertical member;
iv) spring loading the interlock pieces so there is a constant downward push to substantially the width of a single wedge-ended horizontal bar;
v) positioning the slots so all the interlock pieces are arranged in a vertically contacting pile so when a drawer is opened, a wedge-ended horizontal bar displaces the molded interlock pieces between the horizontal bar by the width of the horizontal bar; optionally
vi) locking the cabinet by inserting a locking bar into the interlocking pieces closest to the spring load whilst the spring load is fully extended in an alternate locking procedure;
vii) locking the cabinet by turning a key in a keyhole, the key connected to a locking bracket, which on being turned over protrusion 33 of interlock piece 30 a locks the locking system in an alternate locking procedure.
While the present invention has been described in terms of the preferred embodiments depicted in the drawings and discussed in the above specification, it will be understood by one skilled in the art that the present invention is not limited to these particular preferred embodiments, but includes any and all such modifications that are within the spirit and scope of the present invention as defined in the following claims.

1) A cabinet interlock system comprises a cabinet and a plurality of drawers;
said cabinet interlock system comprising:
a) a cabinet frame, comprising housing for a plurality of drawers and a vertical support member on an inner side panel of the cabinet, wherein said vertical support member comprises slots,
b) a series of vertically stacked interlock pieces held in position by said vertical support member, said series of interlock pieces comprising:
Spacers positioned between said vertical support members and said inner side panel of the cabinet;
protrusion blocks, protruded through said slots in said vertical support member towards the drawers, said protrusion blocks each attached to one end of a spacer wherein two protrusions not connected to the same spacer are arranged as a protrusion pair in each slot, with one protrusion of the pair resting upon the other;
c) a plurality of drawers, movable within the cabinet in a first direction toward an open position, and in a second, opposite direction toward a closed position;
d) a plurality of wedge-ended members, each attached horizontally to one of said drawers; and positioned to penetrate between a protrusion pair of said series of interlock pieces when said drawer is moved in the first direction, and to exit said series of interlock pieces when said drawer is moved in the second direction, wherein said penetration and exit cause displacement of interlock pieces according to the width of said wedge-ended member; and
e) means to spring load said series of interlock pieces to allow displacement of the width of a single wedge-ended member to permit only one drawer to be open at any time, where the spring load member returns the stack to the neutral or closed position.

2) The cabinet interlock system of claim 1 further comprising:
a locking bar;
wherein said series of interlock pieces comprises a first interlock piece closest to said spring loading means and wherein said first interlock piece is provided with a hollow for insertion of said locking bar into; and
wherein said insertion of said locking bar prevents said first interlock piece from displacement against said spring loading means and thereby prevents any drawers from being opened.

3) The cabinet interlock system of claim 2 further comprising:
a) a keyhole;
b) and a key; and
wherein said key is operationally connected to a locking bracket and wherein the turning of said key in said keyhole causes said locking bracket to lock said cabinet interlock system.

4) The cabinet interlock system of claim 1 wherein said spring loading means comprises a spring.

5) The cabinet interlock system of claim 1 wherein said protrusion blocks pair comprise a higher and a lower protrusion, and wherein said higher protrusion comprises a flat upper profile and a tapered lower profile, and wherein said lower protrusion comprises a tapered upper profile and a flat lower profile, wherein said tapered profiles promote the penetration of said wedge-ended member.

6) The cabinet interlock system of claim 1 wherein said spring loading means is positioned above said series of interlock pieces.

7) The cabinet interlock system of claim 6 wherein a lower edge of each of said wedge-members protrudes more than an upper edge thereof, forming said wedge, and wherein said lower edge of each of said wedge-ended members is positioned on a horizontal plane with the point of meeting between a protrusion pair.

8) The cabinet interlock system of claim 1 wherein said spring loading means is positioned below said series of interlock pieces, and wherein an upper edge of each of said wedge-ended members protrudes more than a lower edge thereof, forming said wedge, and wherein said upper edge of each of said wedge-ended members is positioned on a horizontal plane with the point of meeting between a protrusion pair.

9) The cabinet interlock system of claim 1 wherein said slots of said vertical support member comprise T shaped slots, wherein said T shaped slots have a mutually exclusive horizontal and vertical section, wherein said horizontal sections of said T shaped slots are wide enough for the insertion of said interlock pieces into slots and serve as an entry to said slot to enable said interlock pieces to relocate to the base of said vertical section, and wherein said vertical section of said T is adapted to be narrow enough to maintain said protrusions in a column and comprises adequate height for said interlock pieces to be displaced by said wedge-ended member without reaching the horizontal section of said T.

10) The cabinet interlock system of claim 1 wherein said interlock pieces are a single piece comprising a spacer and a tapered protrusion block at each end of the spacer.

11) The cabinet interlock system of claim 1 wherein said interlock pieces are made of polyoxymethylene.

12) The cabinet interlock system of claim 1 wherein said interlock pieces are made of Nylatron®.

13) The cabinet interlock system of claim 1 wherein said interlock pieces are made of abrasion resistant material or polymer having the same characteristics as polyoxmethlylene materials.

14) The cabinet interlock system of claim 1 wherein the interlock pieces made of abrasion resistant material are lubricated.

15) The cabinet interlock system of claim 1 further comprising:
a vertical column member positioned between said spacers; and
said inner side panel of the cabinet to prevent movement of said interlock pieces in directions other than against said spring load means.

16) A method for building a filing cabinet in which more than one drawer cannot be simultaneously opened, comprising:
i) providing a filing cabinet frame with a vertical support member on an inner side surface of the filing cabinet;
ii) attaching a wedge-ended horizontal member to each of a plurality of drawers;
ii) producing T shaped slots on a face of the vertical support that faces the drawers;
iv) inserting the top end of a first molded interlock piece and the bottom end of a second molded interlock piece into each T shaped slot from behind the slot so that protrusion blocks of the interlock pieces protrude towards the drawer while spacers of the interlock pieces remain behind the vertical member;
v) spring loading means to the interlock pieces to limit the displacement to the width of a single wedge-ended horizontal member; and
vi) positioning said interlock pieces so all the molded interlock piece are arranged in a vertically contacting pile so as a drawer is opened, a wedge-ended horizontal member displaces the molded interlock pieces between the horizontal member and the spring loading by the width of the horizontal member.

17) The method of claim 16, further including the step of:
locking the cabinet by inserting a locking bar into the interlocking piece closest to the spring load while the spring load is fully extended.

18) The method of claim 16 for building a section of a filing cabinet in which each section only allows the opening or displacement of one drawer, whereby the different sections will be combined into one cabinet or container.

19) The method of claim 16, further including the step of:
locking the cabinet by turning the key in the keyhole to cause a locking bracket to lock said cabinet locking system.

20) The cabinet interlock system of claim 1 comprising a section as a component of a cabinet or container whereby said cabinet or container will contain sections comprising a plurality of drawers.
